(19) United States
(12) Patent Application Publication
(10) Pub. No.: US 2009/0094281 A1
(43) Pub. Date: Apr. 9, 2009

(54) Systems and methods for transferring combined epigenetic information and other information

(76) Inventors: Edward K.Y. Jung, Bellevue, WA (US); Roderick A. Hyde, Redmond, WA (US); Jordin T. Kare, Seattle, WA (US); Eric C. Leuthhardt, St. Louis, MO (US); Dennis J. Rivet, Portsmouth, VA (US); Lowell L. Wood, JR., Bellevue, WA (US)

Correspondence Address: IV - SUITER SWANTZ PC LLO, 14301 FNB PARKWAY , SUITE 220, OMAHA, NE, 68154, US

(21) Appl. No.: 11/986,986

(22) Filed: Nov. 27, 2007

Related U.S. Application Data
(63) Continuation-in-part of application No. 11/906,995, filed on Oct. 4, 2007.
Application No. 11/906,995 is a continuation-in-part of application No. 11/974,166, filed on Oct. 11, 2007.

(51) Int. Cl. G06F 17/00; G06F 17/30

(52) U.S. Cl. 707/104.1; 707/E17.009

(57) ABSTRACT

A method may include receiving anonymized epigenetic information associated with at least one individual. The anonymized epigenetic information associated with at least one individual may be combined with characteristic data. The combined data may be transferred.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/906,995, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 4, 2007, which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/974,166, entitled SYSTEMS AND METHODS FOR UNDERWRITING RISKS UTILIZING EPIGENETIC INFORMATION, naming Roderick A. Hyde, Jordin T. Kare, Eric C. Leuthardt, Dennis J. Rivet, Michael A. Smith; and Lowell L. Wood, Jr. as inventors, filed Oct. 11, 2007, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### SUMMARY

A method including but not limited to: receiving anonymized epigenetic information associated with at least one individual; combining the anonymized epigenetic information associated with at least one individual and characteristic data; and transferring combined anonymized epigenetic information associated with at least one individual and characteristic data. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

A system including but not limited to: means for receiving anonymized epigenetic information associated with at least one individual; means for combining the anonymized epigenetic information associated with at least one individual and characteristic data; and means for transferring combined anonymized epigenetic information associated with at least one individual and characteristic data. In addition to the foregoing, other method aspects are described in the claims, drawings, and text forming a part of the present disclosure.

A system including but not limited to: circuitry for receiving anonymized epigenetic information associated with at least one individual; circuitry for combining the anonymized epigenetic information associated with at least one individual and characteristic data; and circuitry for transferring combined anonymized epigenetic information associated with at least one individual and characteristic data. In addition to the foregoing, other method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an exemplary environment in which one or more technologies may be implemented.

FIG. 2 illustrates an operational flow representing example operations related to combining epigenetic information with characteristic data and transferring the combined data.

FIG. 3 illustrates an alternative embodiment of the operational flow of FIG. 2.

FIG. 4 illustrates an alternative embodiment of the operational flow of FIG. 2.

FIG. 5 illustrates an alternative embodiment of the operational flow of FIG. 2.

FIG. 6 illustrates an alternative embodiment of the operational flow of FIG. 2.

FIG. 7 illustrates an alternative embodiment of the operational flow of FIG. 2.

FIG. 8 illustrates an alternative embodiment of the operational flow of FIG. 2.

FIG. 9 illustrates an alternative embodiment of the operational flow of FIG. 2.

FIG. 10 illustrates an alternative embodiment of the operational flow of FIG. 2.

FIG. 11 illustrates an alternative embodiment of the operational flow of FIG. 2.

FIG. 12 illustrates an alternative embodiment of the operational flow of FIG. 2.

FIG. 13 illustrates an alternative embodiment of the operational flow of FIG. 2.

FIG. 14 illustrates an alternative embodiment of the operational flow of FIG. 2.

FIG. 15 illustrates an alternative embodiment of the operational flow of FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

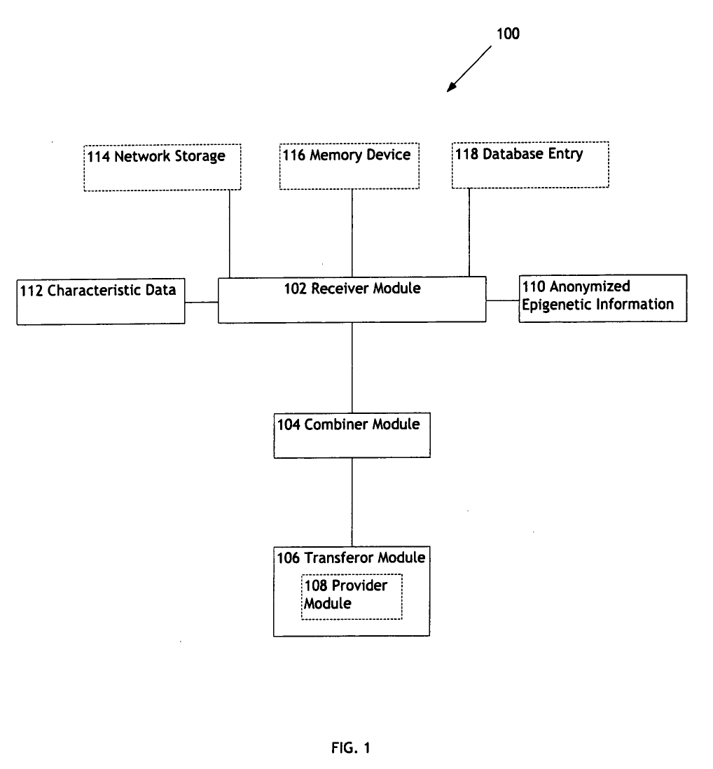

Referring to FIG. 1, a system 100 for combining epigenetic information and other characteristic data and transferring the combined data illustrated. The system 100 may include a receiver module 102, a combiner module 104, and/or a transferor module 110. The receiver module 102 may receive anonymized epigenetic information 110 associated with an individual, such as information regarding a methylation status for that individual, and characteristic data 112, such as lifestyle data. Additionally, the receiver module 102 may receive information and/or data from network storage 114, a memory device 116, and/or a database entry 118. The combiner module 104 may combine epigenetic information (e.g., an individual's methylation status) and characteristic data 112, such as lifestyle data and/or environmental data. Finally, the transferor module 110 may transfer combined information including epigenetic information (e.g., a risk calculated by examining an individual's methylation status) and other characteristic data, such as lifestyle data and/or environmental data. The transferor module 106 may include a provider module 108. The provider module 108 may supply combined epigenetic information and characteristic data to a third party. System 100 generally represents instrumentality for anonymizing epigenetic information. Anonymizing epigenetic information may be accomplished electronically, such as with a set of interconnected electrical components, an integrated circuit, and/or a computer processor.

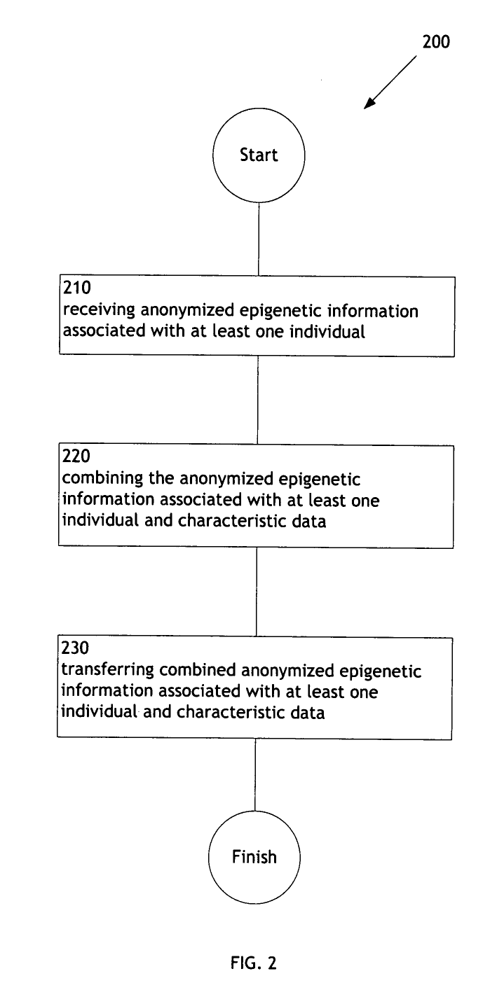

FIG. 2 illustrates an operational flow 200 representing example operations related to receiving anonymized epigenetic information associated with at least one individual, combining the anonymized epigenetic information with characteristic data, and transferring the combined epigenetic information and characteristic data. In FIG. 2 and in following figures that include various examples of operational flows, discussion and explanation may be provided with respect to the above-described examples of FIG. 1, and/or with respect to other examples and contexts. However, it should be understood that the operational flows may be executed in a number of other environments and contexts, and/or in modified versions of FIG. 1. Also, although the various operational flows are presented in the sequence(s) illustrated, it should be understood that the various operations may be performed in other orders than those which are illustrated, or may be performed concurrently.

After a start operation, the operational flow 200 moves to a receiving operation 210, where anonymized epigenetic information associated with at least one individual may be received. For example, as shown in FIG. 1, receiver module 102 may accept anonymized epigenetic information and/or characteristic data. In one specific instance, receiver module 102 may include a computer processor. Some explanation regarding epigenetic information may be found in sources such as Bird, Perceptions of Epigenetics, NATURE 477, 396-398 (2007); Grewat and Elgin, Transcription and RNA Interference in the Formation of Heterochromatin, NATURE 447: 399-406 (2007); and Callinan and Feinberg, The Emerging Science of Epigenomics, HUMAN MOLECULAR GENETICS 15, R95-R101(2006), each of which are incorporated herein by reference. Epigenetic information may include, for example, information regarding DNA methylation, histone states or modifications, transcriptional activity, RNAi, protein binding or other molecular states. Further, epigenetic information may include information regarding inflammation-mediated cytosine damage products. See, e.g., Valinluck and Sowers, Inflammation-Mediated Cytosine Damage: A Mechanistic Link Between Inflammation and the Epigenetic Alterations in Human Cancers, CANCER RESEARCH 67: 5583-5586 (2007), which is incorporated herein by reference.

Then, in a combining operation 220, anonymized epigenetic information associated with at Least one individual and characteristic data may be combined. For example, as shown in FIG. 1, combiner module 104 may incorporate epigenetic information associated with at least one individual and characteristic data. In one specific instance, combiner module 104 may include a computer processor.

Then, in a transferring operation 230, combined anonymized epigenetic information associated with at least one individual and characteristic data may be transferred. For example, as shown in FIG. 1, transferor module 106 may turn over combined anonymized epigenetic information associated with at least one individual and characteristic data to another entity. In one specific instance, transferor module 106 may include a computer processor.

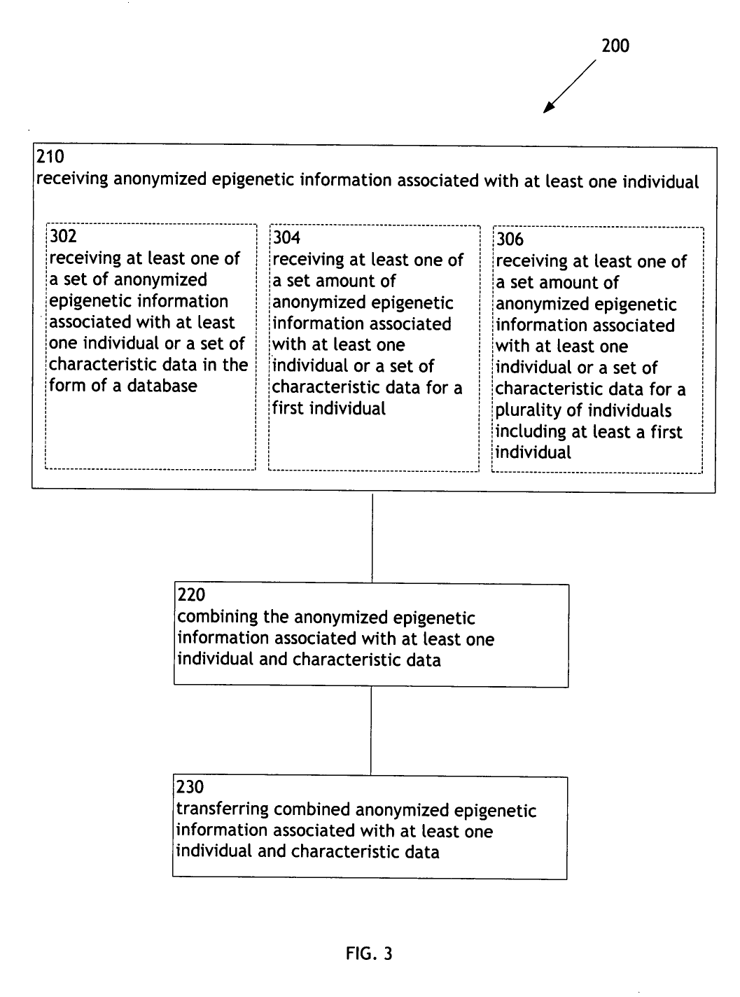

FIG. 3 illustrates alternative embodiments of the example operational flow 200 of FIG. 2. FIG. 3 illustrates example embodiments where the receiving operation 210 may include at least one additional operation. Additional operations may include an operation 302, an operation 304, and/or an operation 306.

At the operation 302, at least one of a set of anonymized epigenetic information associated with at least one individual or a set of characteristic data may be received in the form of a database. For example, as shown in FIG. 1, receiver module 102 may accept from database entry 118 at least one of a set of anonymized epigenetic information associated with at least one individual or a set of characteristic data in the form of a database. In one specific instance, receiver module 102 accepts a set of anonymized information relating to a specific DNA methylation associated with a group of 50 people in the form of a database and a set of characteristic data associated with the same 50 people in the form of a database. A set of information may include a set amount of information and both terms may be used interchangeably herein. Characteristic data may include a wide variety of data related to the character of at least one individual, including health, lifestyle data, environmental data, as well as other types of character information. A database may include a collection of data organized for convenient access. The database may include information digitally stored in a memory device 116, as at least a portion of at least one database entry 118, and/or in network storage 114. In some instances, the database may include information stored non-digitally such as at least a portion of a book, a paper file, and/or a non-computerized index and/or catalog. Non-computerized information may be received by receiver module 102 by scanning or manually entering the information into a digital format. Anonymized epigenetic information may be anonymized in different degrees and by different methods. Different degrees of anonymization may include full anonymization and/or partial anonymization, such as in the case of pseudonym utilization. Methods for anonymizing epigenetic information may include the use of cell suppression and/or utilizing anonymization algorithms. In some instances, receiver module 102 may include a computer processor.

At the operation 304, at least one of a set amount of anonymized epigenetic information associated with at least one individual or a set of characteristic data for a first individual may be received. For example, as shown in FIG. 1, receiver module 102 may accept at least one of a set amount of anonymized epigenetic information associated with at least one individual or a set of characteristic data for a first individual. In one specific instance, receiver module 102 accepts a set of information relating to a specific histone structure indicating a likelihood of heart disease for a first individual and a set of characteristic data for the first individual. In some instances, receiver module 102 may include a computer processor.

At the operation 306, at least one of a set amount of anonymized epigenetic information associated with at least one individual or a set of characteristic data for a plurality of individuals including at least a first individual may be received. For example, as shown in FIG. 1, receiver module 102 may accept at least one of a set amount of anonymized epigenetic information associated with at least one individual or a set of characteristic data for a plurality of individuals including at least a first individual. In one specific instance and continuing with the above example, receiver module 102 accepts a batch of anonymized information related to a specific protein binding to a histone structure indicating a probability of diabetes for the first individual and a second individual and a batch of characteristic data for the first individual and the second individual. A set of information may include batch, finite, and/or discrete amounts information. In some instances, receiver module 102 may include a computer processor.

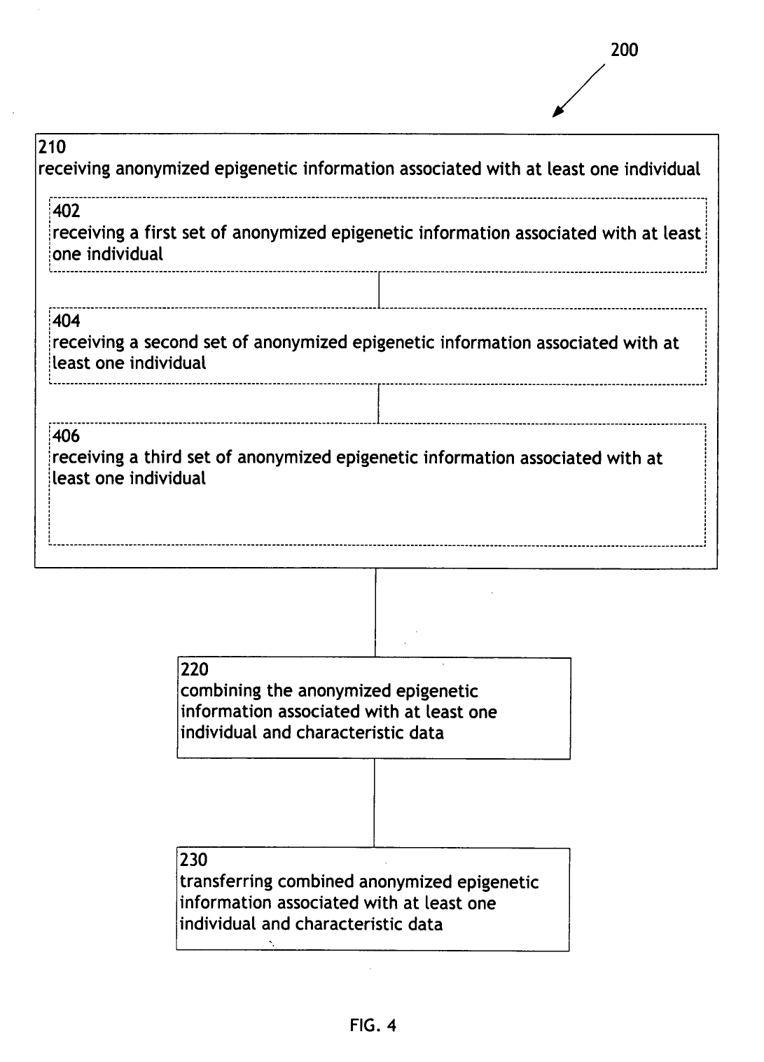

FIG. 4 illustrates alternative embodiments of the example operational flow 200 of FIG. 2. FIG. 4 illustrates example embodiments where the receiving operation 210 may include at least one additional operation. Additional operations may include an operation 402, an operation 404, an operation 406, and/or an operation 408.

At the operation 402, a first set of anonymized epigenetic information associated with at least one individual may be received. For example, as shown in FIG. 1, receiver module 102 may accept a first set of anonymized epigenetic information associated with at least one individual. In one specific instance, receiver module 102 accepts a first batch of anonymized information relating to DNA methylation at a specific site indicating a probability of dementia associated with an individual. Then, at the operation 404, a second set of anonymized epigenetic information associated with at least one individual may be received. For example, as shown in FIG. 1, receiver module 102 may accept a second batch of anonymized information associated with at least one individual. In one instance and continuing with the above example, receiver module 102 accepts a second batch of information relating to DNA methylation at a specific site indicating a probability of dementia associated with the individual. Further, at the operation 406, a third set of anonymized epigenetic information associated with at least one individual may be received. For example, as shown in FIG. 1, receiver module 102 may accept a third set of anonymized epigenetic information associated with at least one individual. In one specific instance and continuing with the above example, receiver module 102 accepts a third batch of information relating to DNA methylation at a specific site indicating a probability of dementia associated with the individual. Additional sets of information may be received by receiver module 102 as batches or finite sets beyond the first, second, and third set of epigenetic information. In some instances, receiver module 102 may include a computer processor.

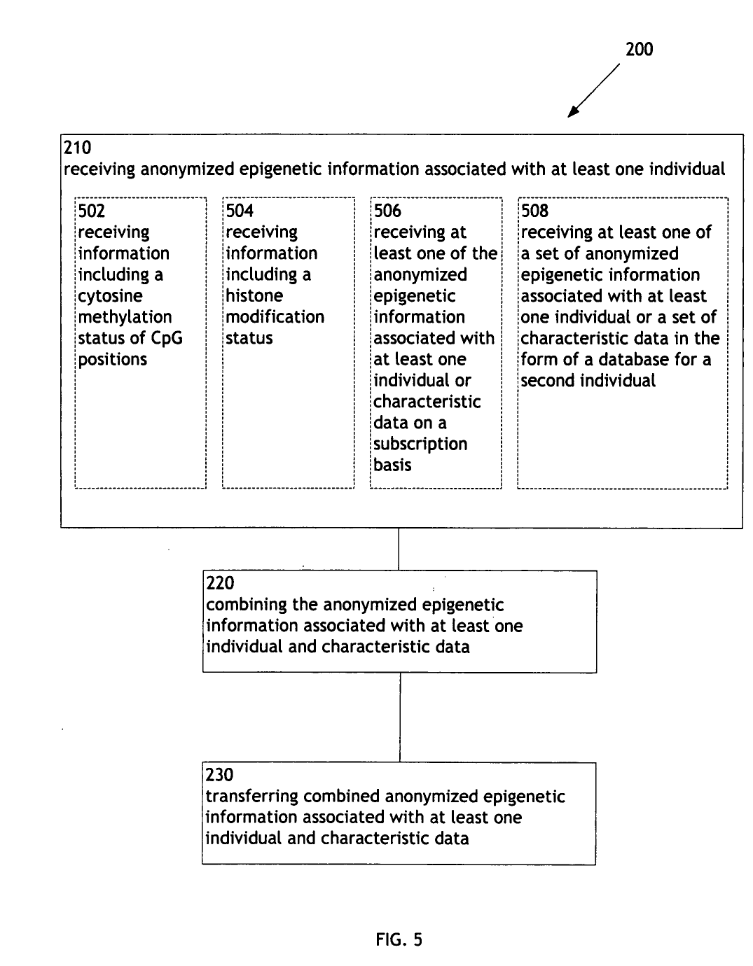

FIG. 5 illustrates alternative embodiments of the example operational flow 200 of FIG. 2. FIG. 5 illustrates example embodiments where the receiving operation 210 may include at least one additional operation. Additional operations may include an operation 502, an operation 504, an operation 506, and/or an operation 508.

At the operation 502, information including a cytosine methylation status of CpG positions may be received. For example, as shown in FIG. 1, receiver module 102 may receive information including a cytosine methylation status of CpG positions. In one specific instance, receiver module 102 receives from memory device 116 information regarding a specific cytosine methylation status of CpG positions. DNA methylation and cytosine methylation status of CpG positions for an individual may include information regarding the methylation status of DNA generally or in the aggregate, or information regarding DNA methylation at one or more specific DNA loci, DNA regions, or DNA bases. See, for example: Shilatifard, Chromatin modifications by methylation and ubiquitination: implications in the regulation of gene expression, ANNUAL REVIEW OF BIOCHEMISTRY, 75:243-269 (2006); and Zhu and Yao, Use of DNA methylation for cancer detection and molecular classification, JOURNAL OF BIOCHEMISTRY AND MOLECULAR BIOLOGY, 40:135-141 (2007), each of which are incorporated herein by reference. In some instances, receiver module 102 may include a computer processor.

At the operation 504, receiving information including a histone modification status may be received. For example, as shown in FIG. 1, receiver module 102 may accept information including a histone modification status. In one instance, receiver module 102 accepts information including a histone modification status. For example, receiving information regarding histone structure and/or histone modification status may include information regarding histone structure generally or in the aggregate, or histone structure at one or more specific locations, including one or more chromosomes. Information regarding histone structure may, for example, include information regarding specific subtypes or classes of histones, such as H1, H2A, H2B, H3 or H4. Information regarding histone structure may have an origin in array-based techniques, such as described in Barski et al., High-resolution profiling of histone methylations in the human genome, CELL 129, 823-837 (2007), which is incorporated herein by reference. In some instances, receiver module 102 may include a computer processor.

At the operation 506, the anonymized epigenetic information and/or characteristic data associated with at least one individual may be received on a subscription basis. For example, as shown in FIG. 1, receiver module 102 may receive epigenetic information and/or characteristic data associated with at least one individual on a subscription basis. The subscription basis may apply to the epigenetic information and/or the characteristic associated with at least one individual. In one specific example, receiver module 102 receives information regarding methylation at a specific DNA base indicating likelihood for cancer. A subscription may include an agreement to receive and/or be given access to the epigenetic information. The subscription may include access to epigenetic information in a digital form and/or a physical form of information, such as paper printouts. For example, an insurance underwriter may purchase access to a database including epigenetic information associated for one year for five thousand dollars. In some instances, receiver module 102 may include a computer processor.

At the operation 508, at least one of a set of anonymized epigenetic information associated with at least one individual or a set of characteristic data in the form of a database for a second individual may be received. For example, as shown in FIG. 1, receiver module 102 may accept at least one of a set of anonymized epigenetic information associated with at least one individual or a set of characteristic data in the form of a database for a second individual. In one specific instance, receiver module 102 accepts a batch of anonymized information relating to a specific histone modification indicating a likelihood of cancer associated with a first individual and a second individual in the form of a database and a batch of characteristic data including dietary data for the first individual and the second individual in the form of a database. In some instances, receiver module 102 may include a computer processor.

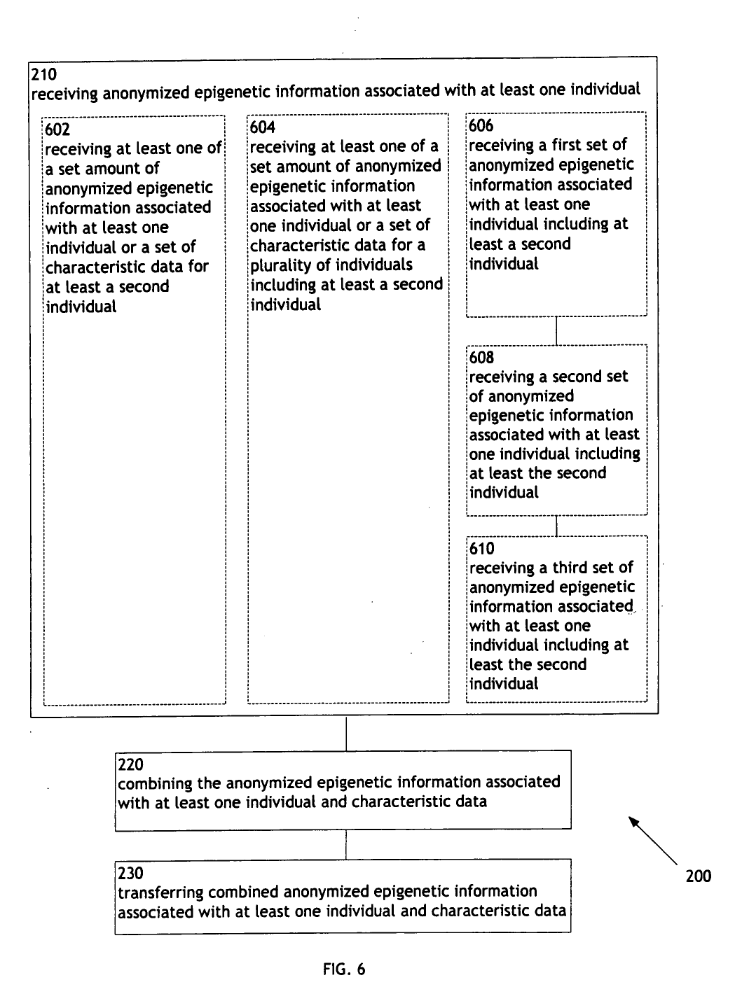

FIG. 6 illustrates alternative embodiments of the example operational flow 200 of FIG. 2. FIG. 6 illustrates example embodiments where the receiving operation 210 may include at least one additional operation. Additional operations may include an operation 602, an operation 604, an operation 606, and/or an operation 608.

At the operation 602, at least one of a set amount of anonymized epigenetic information associated with at least one individual or a set of characteristic data for at least a second individual may be received. For example, as shown in FIG. 1, receiver module 102 may receive at least one of a set amount of anonymized epigenetic information associated with at least one individual or a set of characteristic data for at least a second individual. In one specific example, receiver module 102 receives a batch of anonymized information relating to a specific methylation at a specific DNA site indicating likelihood for diabetes associated with a first individual and a second individual and a batch of characteristic data including allergen amounts in the residence location associated with the first individual and the second individual. In some instances, receiver module 102 may include a computer processor.

At the operation 604, at least one of a set amount of anonymized epigenetic information associated with at least one individual or a set of characteristic data for a plurality of individuals including at least a second individual may be received. For example, as shown in FIG. 1, receiver module 102 may accept at least one of a set amount of anonymized epigenetic information associated with at least one individual or a set of characteristic data for a plurality of individuals including at least a second individual. In one specific instance, receiver module 102 accepts a batch of anonymized information regarding specific transcriptional activity for DNA indicating a probability of lung disease associated with a first individual and a second individual and a batch of characteristic data including nutritional data associated with the first individual and the second individual. In some instances, receiver module 102 may include a computer processor.

At the operation 606, a first set of anonymized epigenetic information associated with at least one individual including at least a second individual may be received. For example, as shown in FIG. 1, receiver module 102 may receive a first set of anonymized epigenetic information associated with at least one individual including at least a second individual. In one specific example, receiver module 102 receives a first batch of anonymized information relating to a specific histone modification indicating a likelihood of kidney failure associated with a first individual and a second individual. Herein, at least a second individual may include an individual in addition to at least one individual. At least a second individual may include a second group of individuals distinct from at least one individual, which may include a first group of individuals. Then, at the operation 608, a second set of anonymized epigenetic information associated with at least one individual including at least the second individual may be received. For example, as shown in FIG. 1, receiver module 102 may receive a second set of anonymized epigenetic information associated with at least one individual including at least a second individual. In a specific instance and continuing with the above example, receiver module 102 receives a second batch of anonymized information relating to a specific histone modification indicating a likelihood of kidney failure associated with a first individual and a second individual. Further, at the operation 610, a third set of anonymized epigenetic information associated with at least one individual including at least the second individual may be received. For example, as shown in FIG. 1, receiver module 102 may accept a third set of anonymized epigenetic information associated with at least one individual including at least the second individual. In a specific instance and continuing with the above example, receiver module 102 receives a third batch of anonymized information relating to a specific histone modification indicating a likelihood of kidney failure associated with a first individual and a second individual. In some instances, receiver module 102 may include a computer processor.

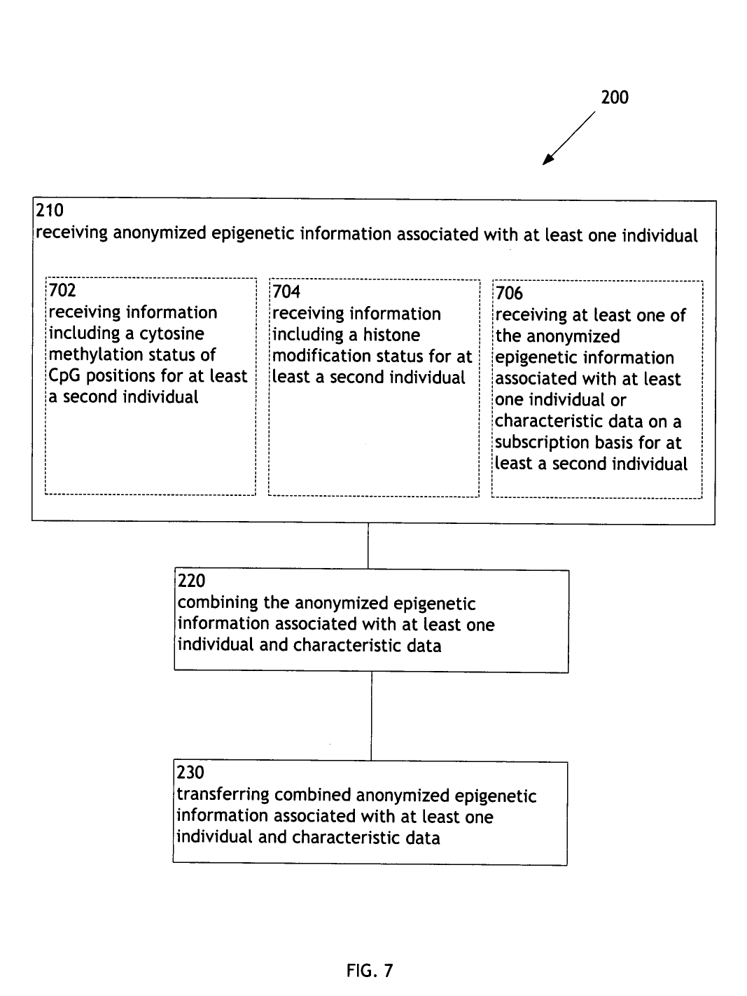

FIG. 7 illustrates alternative embodiments of the example operational flow 200 of FIG. 2. FIG. 7 illustrates example embodiments where the receiving operation 210 may include at least one additional operation. Additional operations may include an operation 702, an operation 704, and/or an operation 706.

At the operation 702, information including a cytosine methylation status of CpG positions for at least a second individual may be received. For example, as shown in FIG. 1, receiver module 102 may accept information including a cytosine methylation status of CpG positions for at least a second individual. In one instance, receiver module 102 accepts epigenetic information including a cytosine methylation status of CpG positions for a second individual. In some instances, receiver module 102 may include a computer processor.

At the operation 704, information including a histone modification status for at least a second individual may be received. For example, as shown in FIG. 1, receiver module 102 may receive information including a histone modification status for at least a second individual. In a specific instance, receiver module 102 receives epigenetic information including a histone modification status for a second individual. In some instances, receiver module 102 may include a computer processor.

At the operation 706, the anonymized epigenetic information and/or characteristic data associated with at least one individual on a subscription basis for at least a second individual may be received. For example, as shown in FIG. 1, receiver module 102 may accept anonymized epigenetic information and/or characteristic data associated with at least one individual on a subscription basis for at least a second individual. In one instance, receiver module 102 accepts anonymized information relating to a methylation at a specific DNA site associated with a first individual and a second individual on a subscription basis. In another instance, receiver module 102 accepts characteristic data relating to a family history associated with a first individual and a second individual on a subscription basis. A subscription may include a transaction wherein a party purchases access to a product and/or service for a period of time. For example, an academic institution may purchase access to a database including epigenetic information for one month for ten thousand dollars. In some instances, receiver module 102 may include a computer processor.

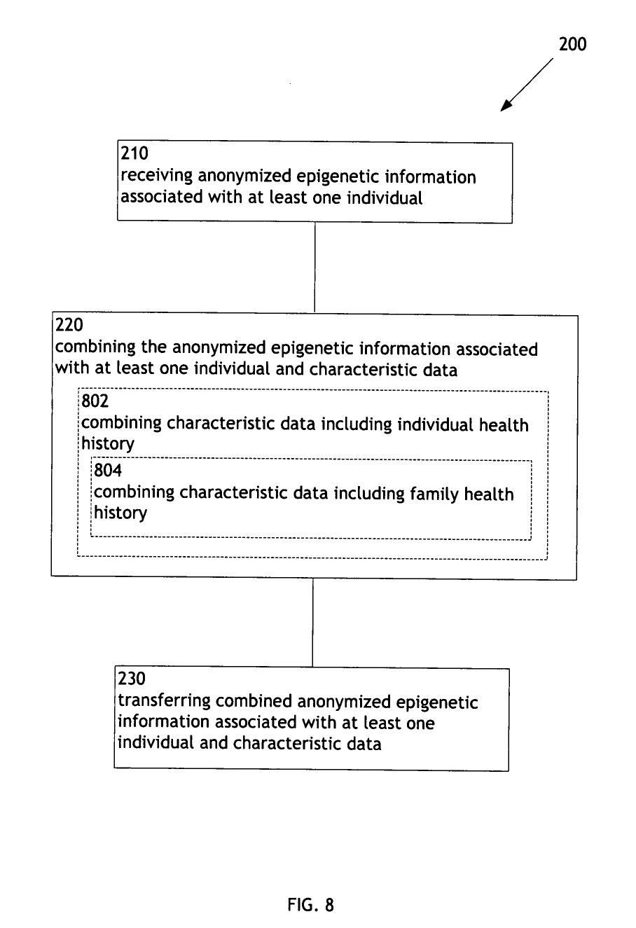

FIG. 8 illustrates alternative embodiments of the example operational flow 200 of FIG. 2. FIG. 8 illustrates example embodiments where the combining operation 220 may include at least one additional operation. Additional operations may include an operation 802, and/or an operation 804.

At the operation 802, characteristic data including individual health history may be combined. For example, as shown in FIG. 1, combiner module 104 may couple anonymized epigenetic information with characteristic data including individual health history. In one specific instance, combiner module 104 couples anonymized epigenetic information with an individual health history for an individual. An individual health history may include past diseases and/or illnesses, medication regiments and/or treatment regiments, and/or past health provider visits, as well as other occurrences relating to an individual's health. Further, at the operation 804, characteristic data including family health history may be combined. For example, as shown in FIG. 1, combiner module 104 may couple anonymized epigenetic information with characteristic data including family health history. In one instance, combiner module 104 couples anonymized epigenetic information with family health history for an individual. A family health history may include occurrences relating to the health of a certain family, including the occurrences of an illness and/or disease, a genetic predisposition to a certain disease, and/or other genetic traits. In some instances, combiner module 104 may include a computer processor.

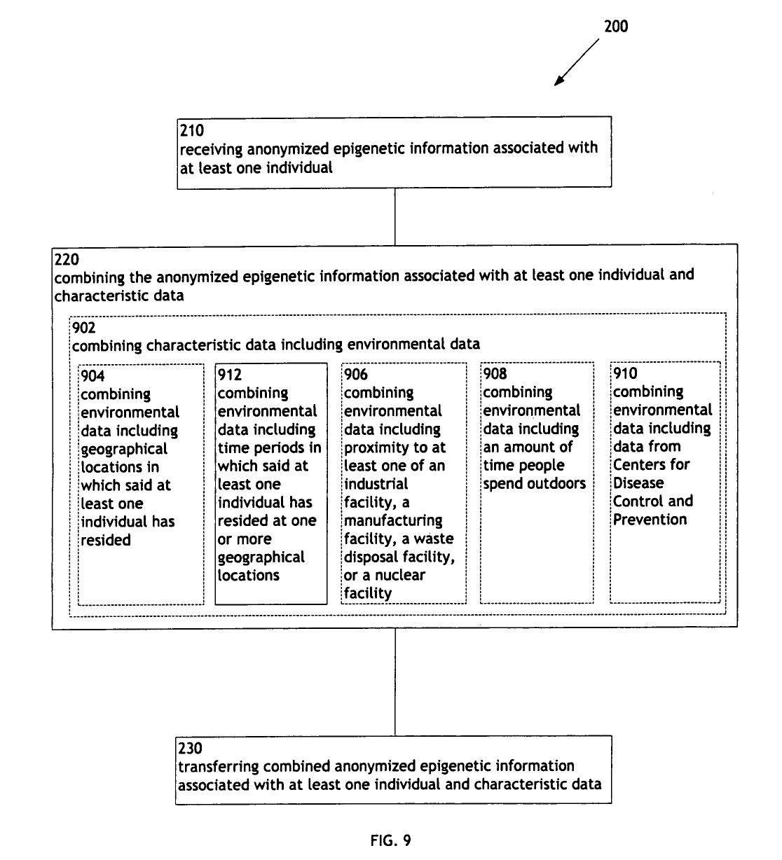

FIG. 9 illustrates alternative embodiments of the example operational flow 200 of FIG. 2. FIG. 9 illustrates example embodiments where the combining operation 220 may include at least one additional operation. Additional operations may include an operation 902, an operation 904, an operation 906, an operation 908, an operation 910, and/or an operation 912.

At the operation 902, characteristic data including environmental data may be combined. For example, as shown in FIG. 1, combiner module 104 may merge anonymized epigenetic information with characteristic data including environmental data. In a specific instance, combiner module 104 merges anonymized epigenetic information with environmental data associated with a specific individual. Environmental data may include information that describes environmental processes, locations, conditions, and/or ecological or health effects and consequences. Further, at the operation 904, environmental data including geographical locations in which said at least one individual has resided may be combined. For example, as shown in FIG. 1, combiner module 104 may merge environmental data including geographical locations in which said at least one individual has resided. In one specific instance, combiner module 104 merges anonymized epigenetic information with a list of geographical locations which an individual has resided, including Newark, N.J., and Los Angeles, Calif. Further, at the operation 912, environmental data including time periods in which said at least one individual has resided at one or more geographical locations may be combined. For example, as shown in FIG. 1, combiner module 104 may merge environmental data including time periods in which said at least one individual has resided at one or more geographical locations. In one instance, combiner module 104 merges anonymized epigenetic information with data including an amount of time an individual has resided in New York City, N.Y. Further, at the operation 906, environmental data including proximity to at least one of an industrial facility, a manufacturing facility, a waste disposal facility, or a nuclear facility may be combined. For example, as shown in FIG. 1, combiner module 104 may merge environmental data including proximity to at least one of an industrial facility, a manufacturing facility, a waste disposal facility, or a nuclear facility. In one instance, combiner module 104 merges anonymized epigenetic information with data including a distance a first individual has resided from an oil refinery and a distance a first individual has resided from a governmental nuclear experiment station. Further, at the operation 908, environmental data including an amount of time people spend outdoors may be combined. For example, as shown in FIG. 1, combiner module 104 may merge environmental data including an amount of time people spend outdoors. The amount of time people spend outdoors may be correlated to an amount of physical activity. In one specific instance, combiner module 104 merges anonymized epigenetic information with data associated with a group of one hundred individuals showing the one hundred individuals spend an average of eleven hours per week outdoors. Further, at the operation 910, environmental data including public health data may be combined. For example, as shown in FIG. 1, combiner module 104 may merge environmental data including public health data. Public health data may include information regarding specific aspects of public health, including mortality rates, the occurrence of disease and/or illness, and/or the rate of visits to a health provider for a certain population, as well as other information. In a specific instance, combiner module 104 merges anonymized epigenetic information with public health data including a mortality rate for the city of San Francisco, Calif. In some instances, combiner module 104 may include a computer processor.

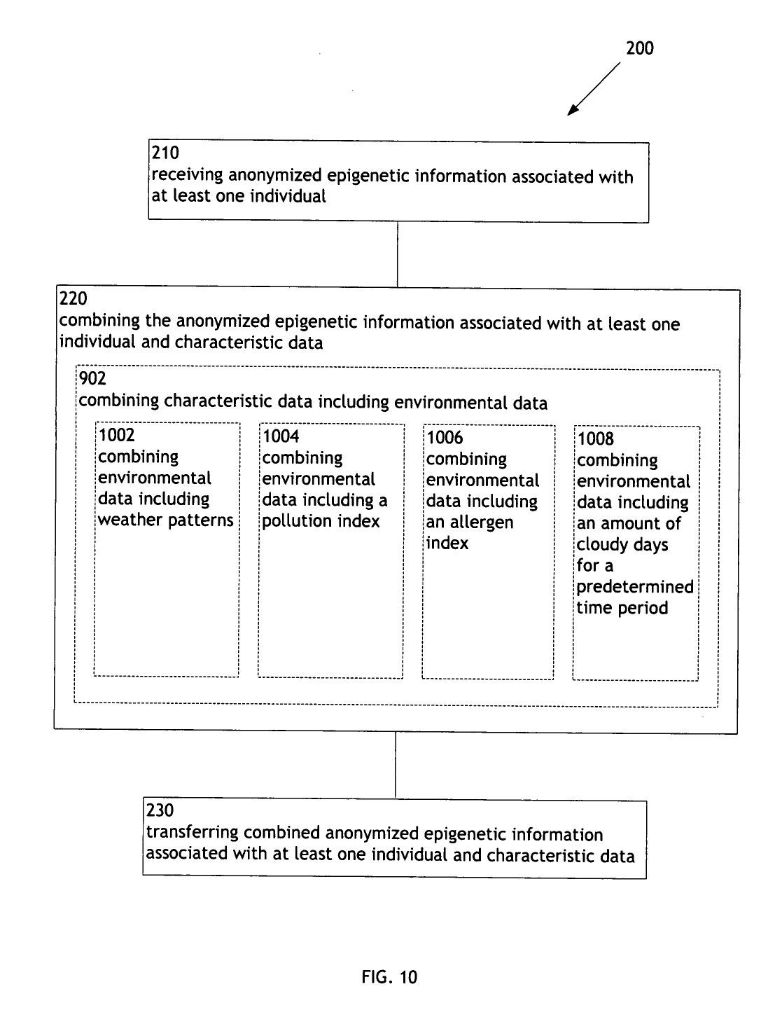

FIG. 10 illustrates alternative embodiments of the example operational flow 200 of FIG. 2. FIG. 10 illustrates example embodiments where the combining operation 220 may include at least one additional operation. Additional operations may include an operation 1002, an operation 1004, an operation 1006, and/or an operation 1008. Further, at the operation 1002, environmental data including weather patterns may be combined. For example, as shown in FIG. 1, combiner module 104 may combine environmental data including weather patterns. In a specific instance, combiner module 104 combines anonymized epigenetic information for an individual living in Florida with environmental data including a weather pattern for Florida indicating an increased likelihood for tropical storms. Information relation to weather may be correlated to an amount of physical activity and/or an amount of stress for an individual and/or a group of individuals. Further, at the operation 1004, environmental data including a pollution index may be combined. For example, as shown in FIG. 1, combiner module 104 may merge environmental data including a pollution index. In a specific instance, combiner module 104 merges anonymized epigenetic information associated with an individual living in Los Angeles in 2003 with environmental data including a pollution index for the year 2003 for the city of Los Angeles, Calif. A pollution index may measure a pollution amount. A pollution index may include a pollution measurement including at least one geographical area and/or at least one time period of exposure to an amount of pollution. A pollution amount may indicate likelihood of disease and/or illness. Further, at the operation 1006, environmental data including an allergen index may be combined. For example, as shown in FIG. 1, combiner module 104 may merge environmental data including an allergen index. In a specific instance, combiner module 104 merges anonymized epigenetic information associated with an individual living in New York City during 2004 with data including an allergen index for New York City during 2004 indicating a high risk of breathing difficulty. An allergen index may be correlated to a stress level and/or a predisposition for illness and/or disease. An allergen index may comprise an allergen measurement including at least one geographical area and/or at least one time period of exposure to an allergen. Further, at the operation 1008, environmental data including an amount of cloudy days for a predetermined time period may be combined. For example, as shown in FIG. 1, combiner module 104 may merge environmental data including an amount of cloudy days for a predetermined time period. In a specific instance, combiner module 104 merges anonymized epigenetic information associated with an individual living in the state of Minnesota during 2006 with data including an amount of cloudy days during 2006 in the state of Minnesota indicating a likelihood of depression. The amount of cloudy days in an area for a certain amount of time may be correlated to a stress level or the predisposition for illness and/or disease. In some instances, combiner module 104 may include a computer processor.

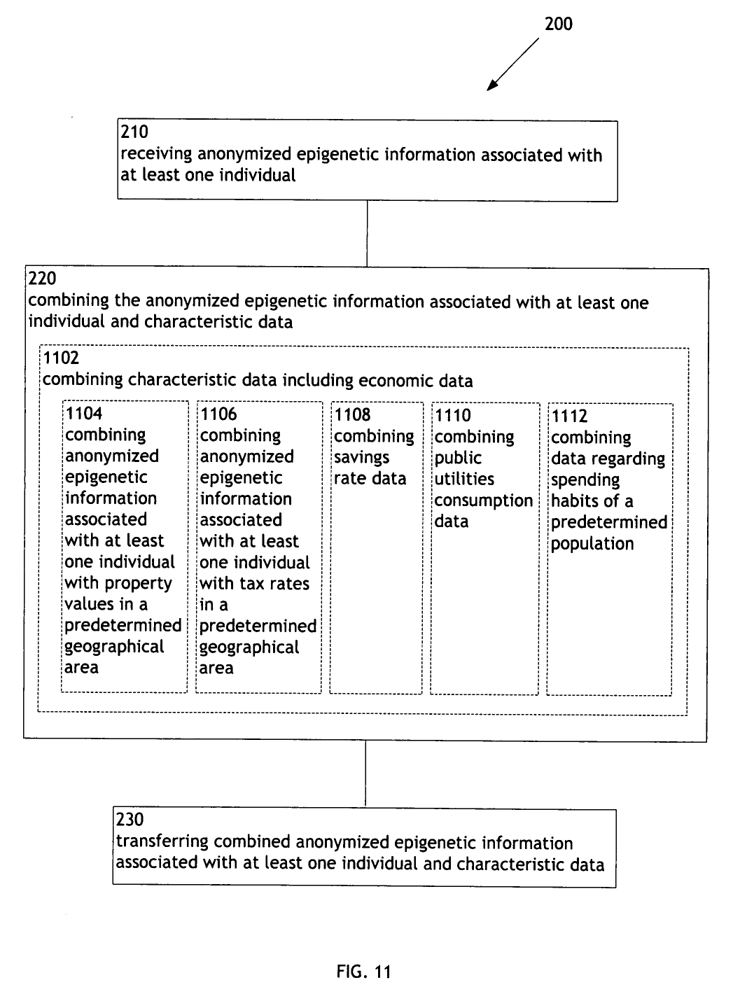

FIG. 11 illustrates alternative embodiments of the example operational flow 200 of FIG. 2. FIG. 11 illustrates example embodiments where the combining operation 220 may include at least one additional operation. Additional operations may include an operation 1102, an operation 1104, an operation 1106, an operation 1108, an operation 1110, and/or an operation 1112.

At the operation 1102, characteristic data including economic data may be combined. For example, as shown in FIG. 1, combiner module 104 may combine characteristic data including economic data. In a specific instance, combiner module 104 combines anonymized epigenetic information associated with at least one individual with economic data for the geographic region in which the individual resides. Further, at the operation 1104, anonymized epigenetic information associated with at least one individual with property values in a predetermined geographical area may be combined. For example, as shown in FIG. 1, combiner module 104 may merge anonymized epigenetic information associated with at least one individual with property values in a predetermined geographical area. In one instance, combiner module 104 merges anonymized epigenetic information associated with a group of fifty thousand individuals living in Las Vegas, Nev. is merged with the average property value in Las Vegas, Nev. Property values in a certain geographic location may indicate a prevalence of disease, illness, and/or stress in that geographic location. Further, at the operation 1106, anonymized epigenetic information associated with at least one individual with tax rates in a predetermined geographical area may be combined. For example, as shown in FIG. 1, combiner module 104 may merge anonymized epigenetic information associated with at least one individual with tax rates in a predetermined geographical area. In a specific instance, combiner module 104 merges anonymized epigenetic information regarding a specific methylated DNA site associated with an individual with an average property tax rate in the state of Illinois. Tax rates in a specific geographic region may indicate a likelihood of stress, disease, and/or other detriments to health. Further, at the operation 1108, combining savings rate data may be combined. For example, as shown in FIG. 1, combiner module 104 may merge savings rate data. In a specific instance, combiner module 104 may merge anonymized epigenetic information associated with an individual with savings rate data for a city in which the individual resides. Further, at the operation 1110, public utilities consumption data may be combined. For example, as shown in FIG. 1, combiner module 104 may merge public utilities consumption data. In a specific instance, combiner module 104 merges anonymized epigenetic information associated with an individual with a rate of natural gas consumption for the city in which the individual resides. Further, at the operation 1112, data regarding spending habits of a predetermined population may be combined. For example, as shown in FIG. 1, combiner module 104 may combine data regarding spending habits of a predetermined population. In a specific instance, combiner module 104 combines anonymized epigenetic information associated with an individual with data regarding the average spending habits of the population of the city in which the individual resides. In some instances, combiner module 104 may include a computer processor.

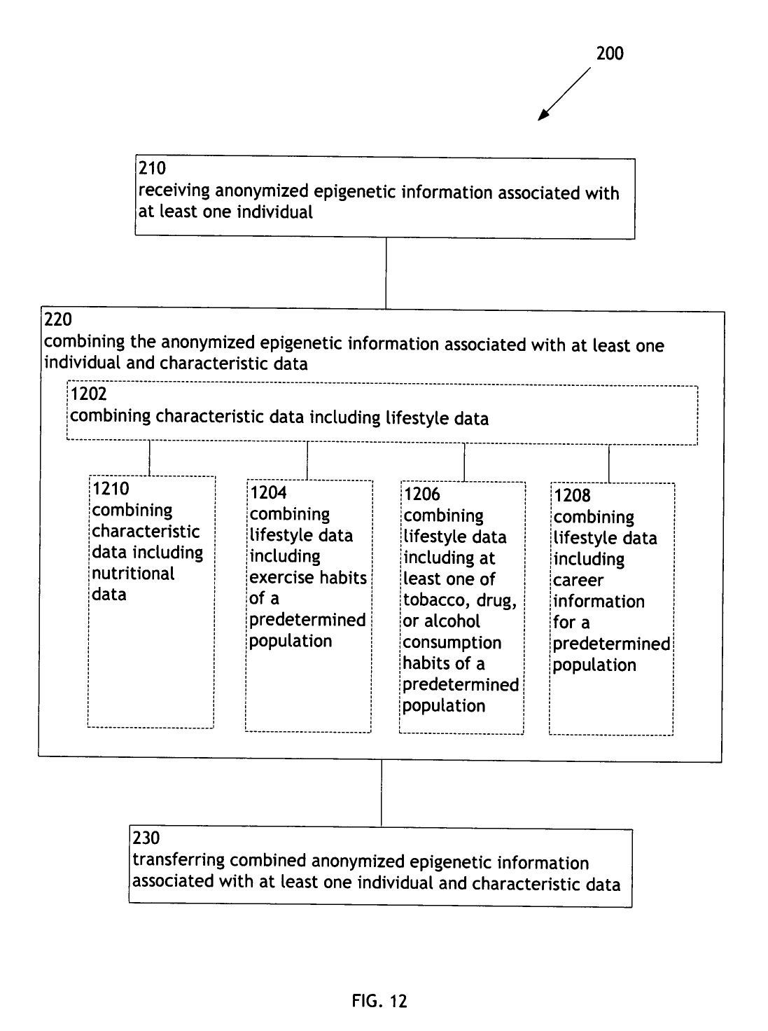

FIG. 12 illustrates alternative embodiments of the example operational flow 200 of FIG. 2. FIG. 12 illustrates example embodiments where the combining operation 220 may include at least one additional operation. Additional operations may include an operation 1202, an operation 1210, an operation 1204, an operation 1206, and/or an operation 1208.

At the operation 1202, characteristic data including lifestyle data may be combined. For example, as shown in FIG. 1, combiner module 104 may combine characteristic data including lifestyle data. In one specific instance, combiner module 104 combines anonymized epigenetic information associated with an individual with lifestyle data. Further, at the operation 1210, lifestyle data including nutritional data may be combined. For example, as shown in FIG. 1, combiner module 104 may combine lifestyle data including nutritional data. In a specific instance, combiner module 104 combines anonymized epigenetic information associated with an individual with nutritional data including the specific diet consumed by a specific individual for a period of one year. Further, at the operation 1204, lifestyle data including exercise habits of a predetermined population may be combined. For example, as shown in FIG. 1, combiner module 104 may combine lifestyle data including exercise habits of a predetermined population. In a specific instance, combiner module 104 combines anonymized epigenetic information associated with an individual with exercise habit information including the amount of gym memberships for the general population of the county in which the individual resides. Further, at the operation 1206, lifestyle data including at least one of tobacco, drug, or alcohol consumption habits of a predetermined population may be combined. For example, as shown in FIG. 1, combiner module 104 may merge lifestyle data including at least one of tobacco, drug, or alcohol consumption habits of a predetermined population. In a specific instance, combiner module 104 merges anonymized epigenetic information associated with an individual with tobacco consumption habits for the general population of the state in which the individual resides. In an alternative instance, combiner module 104 merges anonymized epigenetic information associated with an individual with tobacco, drug, and alcohol consumption habits for the general population of the state in which the individual resides. Further, at the operation 1208, lifestyle data including career information for a predetermined population may be combined. For example, as shown in FIG. 1, combiner module 104 may merge lifestyle data including career information for a predetermined population. In a specific instance, combiner module 104 merges anonymized epigenetic information associated with an individual with lifestyle data including the amount of bankers and physicians for the county in which the individual resides. In some instances, combiner module 104 may include a computer processor.

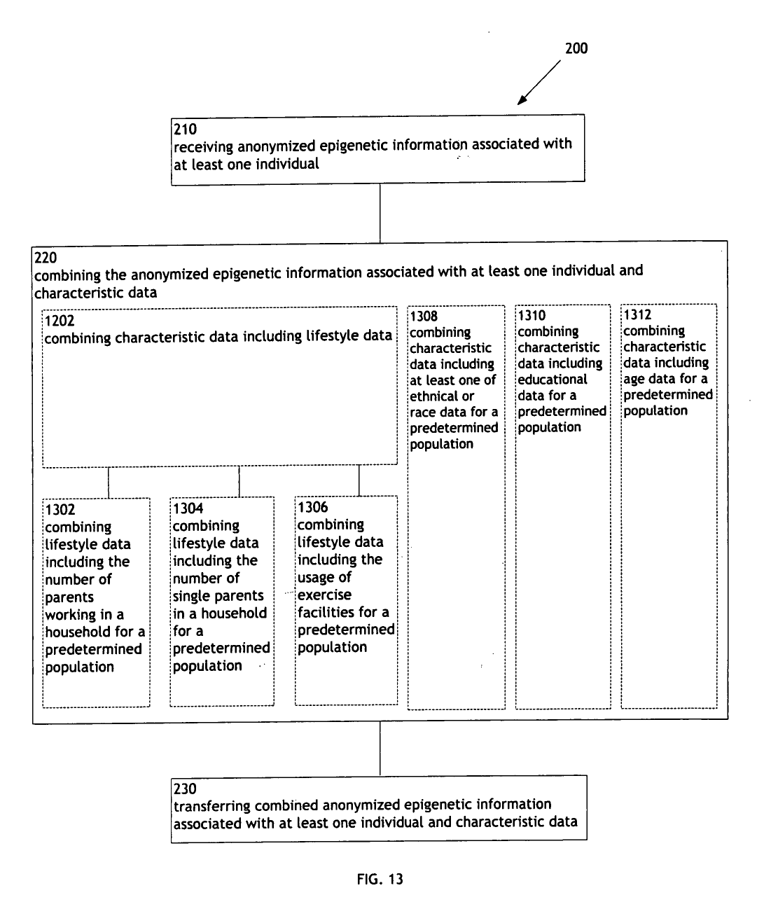

FIG. 13 illustrates alternative embodiments of the example operational flow 200 of FIG. 2. FIG. 13 illustrates example embodiments where the combining operation 220 may include at least one additional operation. Additional operations may include an operation 1302, an operation 1304, an operation 1306, an operation 1308, an operation 1310, and/or an operation 1312. Further, at the operation 1302, lifestyle data including the number of parents working in a household for a predetermined population may be combined. For example, as shown in FIG. 1, combiner module 104 may combine lifestyle data including the number of parents working in a household for a predetermined population. In a specific instance, combiner module 104 combines anonymized epigenetic information associated with an individual with lifestyle data including the total number of parents working in a household for the city in which the individual resides. Further, at the operation 1304, lifestyle data including the number of single parents in a household for a predetermined population may be combined. For example, as shown in FIG. 1, combiner module 104 may combine lifestyle data including the number of single parents in a household for a predetermined population. In a specific instance, combiner module 104 combines anonymized epigenetic information associated with an individual with lifestyle data including the number of single parents in a household for the state in which the individual resides. Further, at the operation 1306, lifestyle data including the usage of exercise facilities for a predetermined population may be combined. For example, as shown in FIG. 1, combiner module 104 may merge lifestyle data including the usage of exercise facilities for a predetermined population. In a specific instance, combiner module 104 combines anonymized epigenetic information associated with an individual with lifestyle data including the average number of gym memberships for the city in which the individual resides. In some instances, combiner module 104 may include a computer processor.

At the operation 1308, characteristic data including at least one of ethnic or race data for a predetermined population may be combined. For example, as shown in FIG. 1, combiner module 104 may merge characteristic data including at least one of ethnic or race data for a predetermined population. In one specific instance, combiner module 104 merges anonymized epigenetic information associated with an individual with characteristic data including data relating to the number of immigrants from a specific area, for example Canada, to the county in which the individual resides. Further, at the operation 1310, characteristic data including educational data for a predetermined population may be combined. For example, as shown in FIG. 1, combiner module 104 may merge characteristic data including educational data for a predetermined population. In a specific instance, combiner module 104 combines anonymized epigenetic information associated with an individual with characteristic data including the average years of schooling for the state of California. Further, at the operation 1312, characteristic data including age data for a predetermined population may be combined. For example, as shown in FIG. 1, combiner module 104 may merge characteristic data including age data for a predetermined population. In a specific instance, combiner module 104 combines anonymized epigenetic information associated with an individual with characteristic data including the average age for the state in which the individual resides. In some instances, combiner module 104 may include a computer processor.

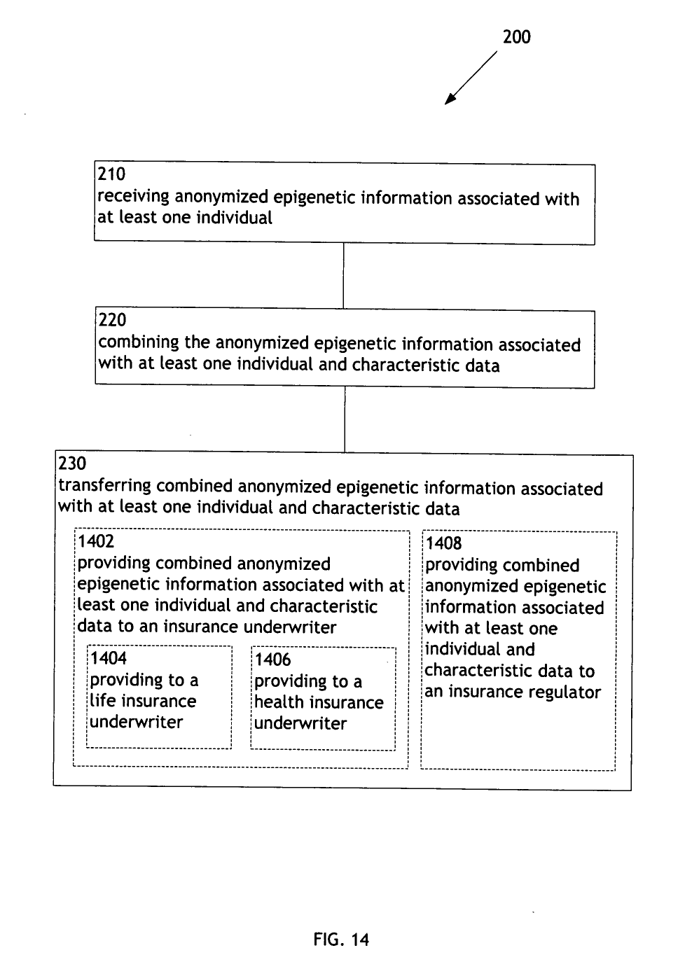

FIG. 14 illustrates alternative embodiments of the example operational flow 200 of FIG. 2. FIG. 14 illustrates example embodiments where the transferring operation 230 may include at least one additional operation. Additional operations may include an operation 1402, an operation 1404, an operation 1406, and/or an operation 1408.

At the operation 1402, combined anonymized epigenetic information associated with at least one individual and characteristic data may be provided to an insurance underwriter. For example, as shown in FIG. 1, provider module 108 may supply combined anonymized epigenetic information associated with at least one individual and characteristic data to an insurance underwriter. In one specific instance, provider module 108 supplies combined anonymized epigenetic information associated with a group of five thousand individuals and associated characteristic data to an insurance underwriter by selling a subscription to the insurance underwriter. Further, at the operation 1404, combined anonymized epigenetic information associated with at least one individual and characteristic data may be provided to a life insurance underwriter. For example, as shown in FIG. 1, provider module 108 may supply combined anonymized epigenetic information associated with at least one individual and characteristic data to an insurance underwriter. In one specific instance, provider module 108 supplies combined anonymized epigenetic information associated with a group of twenty thousand individuals and associated characteristic data to a life insurance underwriter by selling a batch of information to the life insurance underwriter. Further, at the operation 1406, combined anonymized epigenetic information associated with at least one individual and characteristic data may be provided to a health insurance underwriter. For example, as shown in FIG. 1, provider module 108 may supply combined anonymized epigenetic information associated with at least one individual and characteristic data to a health insurance underwriter. In one specific instance, provider module 108 supplies combined anonymized epigenetic information associated with a group of one thousand individuals and associated characteristic data to a health insurance underwriter by selling a three year subscription of information to the health insurance underwriter. In some instances, provider module 108 may include a computer processor.

At the operation 1408, combined anonymized epigenetic information associated with at least one individual and characteristic data may be provided to an insurance regulator. For example, as shown in FIG. 1, provider module 108 may supply combined anonymized epigenetic information associated with at least one individual and characteristic data to an insurance regulator. In one specific instance, provider module 108 supplies combined anonymized epigenetic information associated with a group of fifteen thousand individuals and associated characteristic data to a health insurance regulator by selling a three year subscription of information to an insurance regulator. In some instances provider module 108 may include a computer processor.

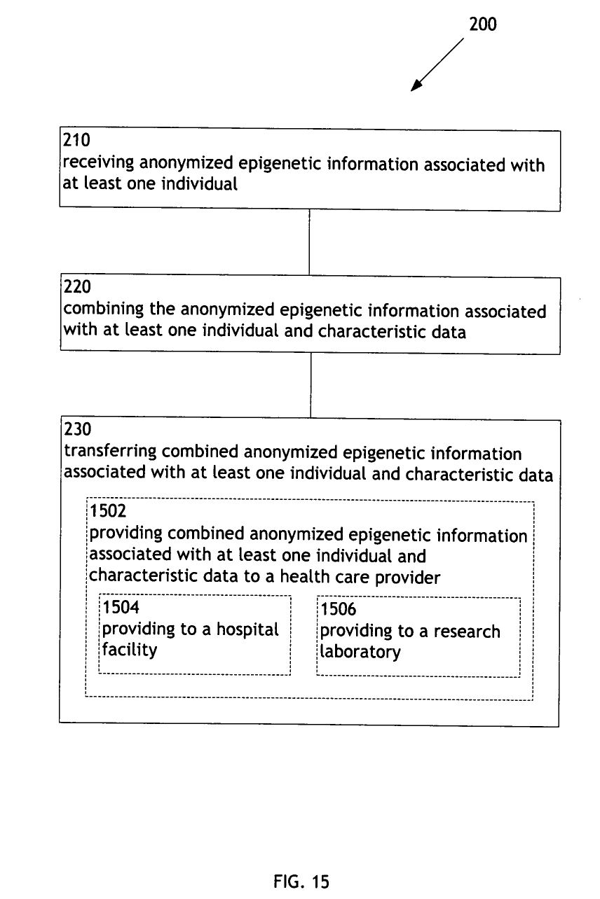

FIG. 15 illustrates alternative embodiments of the example operational flow 200 of FIG. 2. FIG. 15 illustrates example embodiments where the transferring operation 230 may include at least one additional operation. Additional operations may include an operation 1502, an operation 1504, and/or an operation 1506.

At the operation 1502, combined anonymized epigenetic information associated with at least one individual and characteristic data may be provided to a health care provider. For example, as shown in FIG. 1, provider module 108 may supply combined anonymized epigenetic information associated with at least one individual and characteristic data to a health care provider. A health care provider may include at least one person, agency, department, unit, subcontractor, and/or other entity that delivers a health-related service. In one specific instance, provider module 108 supplies combined anonymized epigenetic information associated with a group of five hundred individuals and associated characteristic data to a health care provider by selling a six month subscription of information to the health care provider. Further, at the operation 1504, combined anonymized epigenetic information associated with at least one individual and characteristic data may be provided to a hospital facility. For example, as shown in FIG. 1, provider module 108 may supply combined anonymized epigenetic information associated with at least one individual and characteristic data to a hospital facility. A hospital facility may include an institution whose primary function is to provide inpatient and/or outpatient diagnostic and therapeutic services for a variety of medical conditions, both surgical and non-surgical. In one specific instance, provider module 108 supplies combined anonymized epigenetic information associated with a group of one thousand individuals and associated characteristic data to a hospital facility by selling a three year subscription of information to the hospital facility. Further, at the operation 1506, combined anonymized epigenetic information associated with at least one individual and characteristic data may be provided to a research laboratory. For example, as shown in FIG. 1, provider module 108 may provide combined anonymized epigenetic information associated with at least one individual and characteristic data to a research laboratory. In one specific instance, provider module 108 provides combined anonymized epigenetic information associated with a group of one hundred individuals and associated characteristic data to a research laboratory by selling a three year subscription of information to the research laboratory. A research laboratory may include academic institutions, private research institutions, and/or commercial entities. In some instances provider module 108 may include a computer processor.

Those having skill in the art will recognize that the state of the art has progressed to the point where there is little distinction Left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle wilt vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly intractable and/or wirelessly interacting components and/or logically interacting and/or logically intractable components.

White particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope alt such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art wilt recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method comprising:
receiving anonymized epigenetic information associated with at least one individual;
combining the anonymized epigenetic information associated with at least one individual and characteristic data; and
transferring combined anonymized epigenetic information associated with at least one individual and characteristic data.

2-53. (canceled)

54. A system comprising:
means for receiving anonymized epigenetic information associated with at least one individual;
means for combining the anonymized epigenetic information associated with at least one individual and characteristic data; and
means for transferring combined anonymized epigenetic information associated with at least one individual and characteristic data.

55. The system of claim 54, wherein means for receiving anonymized epigenetic information associated with at least one individual comprises:
means for receiving at least one of a set of anonymized epigenetic information associated with at least one individual or a set of characteristic data in the form of a database.

56. The system of claim 54, wherein means for receiving anonymized epigenetic information associated with at least one individual comprises:
means for receiving at least one of a set amount of anonymized epigenetic information associated with at least one individual or a set of characteristic data for a first individual.

57. (canceled)

58. The system of claim 54, wherein means for receiving anonymized epigenetic information associated with at least one individual comprises:
means for receiving a first set of anonymized epigenetic information associated with at least one individual; and
means for receiving a second set of anonymized epigenetic information associated with at least one individual.

59. The system of claim 58, further comprising:
means for receiving a third set of anonymized epigenetic information associated with at least one individual.

60. The system of claim 54, wherein means for receiving anonymized epigenetic information associated with at least one individual comprises:
means for receiving information including a cytosine methylation status of CpG positions.

61. The system of claim 54, wherein means for receiving anonymized epigenetic information associated with at least one individual comprises:
means for receiving information including a histone modification status.

62. The system of claim 54, wherein means for receiving anonymized epigenetic information associated with at least one individual comprises:
means for receiving at least one of the anonymized epigenetic information associated with at least one individual or characteristic data on a subscription basis.

63. The system of claim 54, wherein means for receiving anonymized epigenetic information associated with at least one individual comprises:
means for receiving at least one of a set of anonymized epigenetic information associated with at least one individual or a set of characteristic data in the form of a database for at least a second individual.

64. The system of claim 54, wherein means for receiving anonymized epigenetic information associated with at least one individual comprises:
means for receiving at least one of a set amount of anonymized epigenetic information associated with at least one individual or a set of characteristic data for at least a second individual.

65. The system of claim 54, wherein means for receiving anonymized epigenetic information associated with at least one individual comprises:
means for receiving at least one of a set amount of anonymized epigenetic information associated with at least one individual or a set of characteristic data for a plurality of individuals including at least a second individual.

66. The system of claim 54, wherein means for receiving anonymized epigenetic information associated with at least one individual comprises:
means for receiving a first set of anonymized epigenetic information associated with at least one individual including at least a second individual; and
means for receiving a second set of anonymized epigenetic information associated with at least one individual including at least the second individual.

67. The system of claim 58, further comprising:
means for receiving a third set of anonymized epigenetic information associated with at least one individual including at least the second individual.

68. The system of claim 54, wherein means for receiving anonymized epigenetic information associated with at least one individual comprises:
means for receiving information including a cytosine methylation status of CpG positions for at least a second individual.

69. The system of claim 54, wherein means for receiving anonymized epigenetic information associated with at least one individual comprises:
means for receiving information including a histone modification status for at least a second individual.

70. The system of claim 54, wherein means for receiving anonymized epigenetic information associated with at least one individual comprises:
means for receiving at least one of the anonymized epigenetic information associated with at least one individual or characteristic data on a subscription basis for at least a second individual.

71. The system of claim 54, wherein means for combining the anonymized epigenetic information associated with at least one individual and characteristic data comprises:
means for combining characteristic data including individual health history.

72. (canceled)

73. The system of claim 54, wherein means for combining the anonymized epigenetic information associated with at least one individual and characteristic data comprises:
means for combining characteristic data including environmental data.

74. The system of claim 73, wherein means for combining characteristic data including environmental data comprises:
means for combining environmental data including geographical locations in which said at least one individual has resided.

75. The method of claim 73, wherein means for combining characteristic data including environmental data comprises:
means for combining environmental data including time periods in which said at least one individual has resided at one or more geographical locations.

76. The system of claim 73, wherein means for combining characteristic data including environmental data comprises:
means for combining environmental data including proximity to at least one of an industrial facility, a manufacturing facility, a waste disposal facility, or a nuclear facility.

77. (canceled)

78. The system of claim 73, wherein means for combining characteristic data including environmental data comprises:
means for combining environmental data including public health data.

79. The system of claim 73, wherein means for combining characteristic data including environmental data comprises:
means for combining environmental data including weather patterns.

80. The system of claim 73, wherein means for combining characteristic data including environmental data comprises:
means for combining environmental data including a pollution index.

81. The system of claim 73, wherein means for combining characteristic data including environmental data comprises:
means for combining environmental data including an allergen index.

82. (canceled)

83. The system of claim 54, wherein means for combining the anonymized epigenetic information associated with at least one individual and characteristic data comprises:
means for combining characteristic data including economic data.

84. (canceled)

85. The system of claim 83, wherein means for combining characteristic data including economic data comprises:
means for combining anonymized epigenetic information associated with at least one individual with tax rates in a predetermined geographical area.

86. (canceled)

87. The system of claim 83, wherein means for combining characteristic data including economic data comprises:
means for combining public utilities consumption data.

88. The system of claim 83, wherein means for combining characteristic data including economic data comprises:
means for combining data regarding a spending habit of a predetermined population.

89. The system of claim 54, wherein means for combining the anonymized epigenetic information associated with at least one individual and characteristic data comprises:
means for combining characteristic data including lifestyle data.

90. The method of claim 89, wherein means for combining characteristic data including lifestyle data comprises:
means for combining characteristic data including nutritional data.

91. (canceled)

92. The system of claim 89, wherein means for combining characteristic data including lifestyle data comprises:
means for combining lifestyle data including at least one of tobacco, drug, or alcohol consumption habits of a predetermined population.

93. The system of claim 89, wherein means for combining characteristic data including lifestyle data comprises:
means for combining lifestyle data including career information for a predetermined population.

94-95. (canceled)

96. The system of claim 89, wherein means for combining characteristic data including lifestyle data comprises:
means for combining lifestyle data including the usage of exercise facilities for a predetermined population.

97. The system of claim 54, wherein means for combining the anonymized epigenetic information associated with at least one individual and characteristic data comprises:
means for combining characteristic data including at least one of ethnical or race data for a predetermined population.

98. The method of claim 54, wherein means for combining the anonymized epigenetic information associated with at least one individual and characteristic data comprises:
means for combining characteristic data including educational data for a predetermined population.

99. The method of claim 54, wherein means for combining the anonymized epigenetic information associated with at least one individual and characteristic data comprises:
means for combining characteristic data including age data for a predetermined population.

100. The system of claim 54, wherein means for transferring combined anonymized epigenetic information associated with at least one individual and characteristic data comprises:
means for providing combined anonymized epigenetic information associated with at least one individual and characteristic data to an insurance underwriter.

101-102. (canceled)

103. The system of claim 54, wherein means for transferring combined anonymized epigenetic information associated with at least one individual and characteristic data comprises:
means for providing combined anonymized epigenetic information associated with at least one individual and characteristic data to an insurance regulator.

104. The system of claim 54, wherein means for transferring combined anonymized epigenetic information associated with at least one individual and characteristic data comprises:
means for providing combined anonymized epigenetic information associated with at least one individual and characteristic data to a health care provider.

105-106. (canceled)

107. A system comprising:
circuitry for receiving anonymized epigenetic information associated with at least one individual;
circuitry for combining the anonymized epigenetic information associated with at least one individual and characteristic data; and
circuitry for transferring combined anonymized epigenetic information associated with at least one individual and characteristic data.
